(19) United States
(12) Patent Application Publication
(10) Pub. No.: US 2010/0091410 A1
(43) Pub. Date: Apr. 15, 2010

(54) Magnetic read/write head and magnetic read/write apparatus having same

(75) Inventors: Kousuke Innami, Osaka-Shi (JP); Shintaro Miyanishi, Osaka-Shi (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/587,527

(22) Filed: Oct. 8, 2009

(30) Foreign Application Priority Data
Oct. 14, 2008 (JP) 2008-265656

(51) Int. Cl. G11B 5/48

(52) U.S. Cl. 360/246.2; G9B/5.147

(57) ABSTRACT

A magnetic read/write head includes: a slider having an ABS, a surface at an leading edge, and a surface at an trailing edge; a piezoelectric device arranged on the surface at the trailing edge of the slider; and a magnetic read/write element arranged on the piezoelectric device. The piezoelectric device, upon application of voltage, is displaced asymmetrically with respect to a displacement axis which is on the surface at the trailing edge of the slider and which is perpendicular to the surface of the magnetic recording medium. With this asymmetrical displacement of the piezoelectric device, the magnetic read/write element rotates about the rotation axis perpendicular to the surface of the magnetic recording medium.

### CROSS REFERENCE TO RELATED APPLICATION

The present application claims priority from Japanese Patent Application No. 2008-265656, which was filed on Oct. 14, 2008, the disclosure of which is herein incorporated by reference in its entirety.

### BACKGROUND OF THE INVENTION

1. Field of the Invention

The present invention relates to a magnetic read/write apparatus capable of performing magnetic recording of magnetized information on and reproduction of the same recorded on a highly densified magnetic recording medium, and a magnetic read/write apparatus having such a magnetic read/write head.

2. Description of the Related Art

The development of information society necessitates handling of a massive amount of information, consequently leading to a demand for a read/write apparatus having a larger volume and a higher density. An example of prevalent read/write apparatuses is a magnetic read/write apparatus whose per-bit cost is low and which is involatile and capable of recording a massive amount of information, and development of a magnetic read/write apparatus capable of performing high density recording.

The magnetic read/write apparatus records magnetized information along a data track of a magnetic recording medium. When reading recorded magnetized information, the apparatus moves a magnetic read/write element to an intended data track to read information recorded thereon. To accurately read data recorded on the magnetic recording medium with the magnetic read/write element, the magnetic read/write head needs to be highly accurately positioned at the data track center.

The following describes a data track positioning (hereinafter, tracking) mechanism and a tracking control method, for the magnetic read/write head to move a desired data track on the magnetic recording medium and stay in the data track center position while recording/reproducing information.

First described is the tracking mechanism. The magnetic read/write head is fixed on a slider provided with an air bearing surface (hereinafter, “ABS”). The slider is fixed on a component called suspension, and the suspension is structured by two components: a load beam and a gimbal. With this, the magnetic read/write head fixed on the slider is able to lift up above the rotating magnetic recording medium. The load beam ensures stable flying by generating a constant load on the slider. The gimbal is a spring-like component which absorbs side-runout of the magnetic recording medium and tilt associated with the assembly of the magnetic read/write head and realizes high capability for tracking data tracks. The suspension is fixed on a swing arm. Driving the swing arm with the voice coil motor (VCM) moves the magnetic read/write head to the position of a desired data track, thus enabling positioning relative to the data track.

Next, the following describes a tracking control method. Tracking control of the magnetic read/write head on the magnetic recording medium is performed as follows. First, servo information written in the magnetic recording medium is read out by the magnetic read/write head, and is analyzed by a signal processing system. Then, signals are transmitted to the magnetic read/write signal drive unit, and drive the support arm with the voice coil motor to move the magnetic read/write head to a desired data track. Subsequently, the servo information written in the magnetic recording medium is read out by using the magnetic read/write head having reached the desired data track so as to analyze the amount of displacement of the center of the magnetic read/write element in relation to the center of the desired data track. Then, to the magnetic read/write head drive unit is transmitted a signal indicative of an amount the magnetic read/write element needs to be moved which amount is calculated from the amount of displacement. Based on the signal, the support arm is driven with the voice coil motor to bring the center of the magnetic read/write element to the center of the desired data track.

Repeating the above operation enables the magnetic read/write head to follow the desired data track. The VCM which generates a drive force for driving the support arm allows highly accurate positioning of the magnetic read/write head in a desired position of the magnetic recording medium.

The accuracy of the above positioning needs to be higher with an increase in the density of data tracks on the magnetic recording medium. This is because, when data tracks are close to each other, a slight displacement of the magnetic read/write head in the width direction of the data track could delete data written in an adjacent data track. For example, in a high density magnetic recording medium of 1 T bit/inch², the track pitch is expected to be 50 nm or smaller. In such a case, the accuracy of positioning in the direction of the data track needs to be from sub-nanometer to nanometer order.

IDEMA Japan News No. 45, p6 reports that the tracking limit of a magnetic read/write apparatus having a positioning mechanism with only the existing VCM is information recording medium of approximately 0.3 μm in track pitch. In a magnetic read/write apparatus, positioning in the data track direction needs to be as accurate as 10% or less of the track pitch. Based on the above track pitch, the accuracy of positioning with the voice coil motor is approximately 30 nm. Thus, positioning only with VCM is difficult in the above mentioned highly densified magnetic read/write medium.

To solve this problem, Japanese Unexamined Patent Publication No. 259905/1994 (Tokukaihei 6-259905) discloses providing a micromotion mechanism in which a pair of thin plates and a piezoelectric device are integrated between a slider and a suspension, so as to drive the piezoelectric device to slightly displace the slider. Further, to solve the above problem, Japanese Unexamined Patent Publication No. 247027/2004 (Tokukai 2004-247027) discloses provision of a rotary electrostatic actuator between a slider and a suspension to realize prompt and highly accurate positioning in relation to a track, and allow a magnetic read/write head to move and track at a high bandwidth.

In both Tokukaihei 6-259905 and Tokukai 2004-247027, a micromotion actuator is provided as a secondary micromotion mechanism between the slider and suspension in addition to the VCM. The slight movement is enabled with the micromotion actuator while large movement with the VCM. It is therefore possible to realize both a wide movement range and a highly accurate tracking, and the above structure is very effective for use in a magnetic read/write apparatus for a high density magnetic recording media.

In addition, to solve the above mentioned problem, Japanese Unexamined Patent Publication No. 230464/2001 (Tokukai 2001-230464) discloses provision of a piezoelectric device in the slider so as to enable slight movement of the magnetic read/write element in a specific direction.

### SUMMARY OF THE INVENTION

However, the above mentioned Tokukaihei 6-259905 and Tokukai 2004-247027 causes complicated structure of the micromotion actuator, which makes assembling the suspension, micromotion actuator, and the magnetic read/write head difficult. Thus, these are not feasible technology in commercialization, in terms of productivity.

Further, Japanese Unexamined Patent Publication No. 230464/2001 (Tokukai 2001-230464) yields better productivity without a need of complicated assembling of the suspension, micromotion actuator, and magnetic read/write head. However, the magnetic read/write head of this publication only allows linear movement of the magnetic read/write element in a specific direction, and it is difficult to rotate the magnetic read/write element about a shaft perpendicular to the surface of the magnetic recording medium so as to move the element in the direction of the data track. When the magnetic read/write element is tilted by a predetermined angle, and forms an angle with respect to the data track, a voice coil motor is needed in addition to the piezoelectric device, even in a slight adjustment for tracking. It is therefore difficult to perform highly accurate positioning.

It is an object of the present invention to provide a magnetic read/write head which is excellent in productivity, and is capable of rotating its magnetic read/write element about a shaft perpendicular to the surface of a magnetic recording medium. It is also an object of the present invention to provide a magnetic read/write apparatus having such a magnetic read/write head.

A magnetic read/write head of the present invention includes: a slider having an ABS facing a magnetic recording medium, a surface perpendicular to an air stream at a leading edge where air flows in a space between the ABS and the magnetic recording medium, and a surface perpendicular to the air stream at a trailing edge where air flows out from the space between the ABS and the magnetic recording medium; a piezoelectric device arranged on the trailing edge surface of the slider, which is, upon application of voltage, displaced asymmetrically with respect to a displacement axis on the surface at the trailing edge of the slider, the displacement axis being perpendicular to the surface of the magnetic recording medium; and a magnetic read/write element arranged on the piezoelectric device, which rotates about a rotation axis perpendicular to the surface of the magnetic recording medium with the asymmetrical displacement of the piezoelectric device.

With this, the magnetic read/write element is rotated about the rotation axis perpendicular to the surface of the magnetic recording medium, by the asymmetrical displacement of the piezoelectric device with application of voltage. Further, the simple structure of having the piezoelectric device sandwiched between the slider and the magnetic read/write element is also advantageous in terms of productivity.

The term “piezoelectric” means an ability of material to deform upon application of an electric field. Materials exhibiting significant deformation are referred to as piezoelectric materials. Further, a device having two or more electrodes sandwiching a piezoelectric material to enable telescopic driving of the piezoelectric material with application of electric field is referred to as piezoelectric device. The telescopic driving of the piezoelectric device is determined by the product of voltage applied in the thickness direction of the piezoelectric device and the unique piezoelectric constant of the piezoelectric material. The piezoelectric constant is an index to express how easily the piezoelectric material deforms when voltage is applied to the piezoelectric device.

That is, when voltage applied to piezoelectric material is made different within a single piezoelectric device (hereinafter referred to as distribution of voltage application to the piezoelectric device), the piezoelectric material exhibits different amounts of displacement (amount of expansion or constriction), according to the voltage applied. Thus, within the piezoelectric device, different amounts of expansion and constriction are distributed.

The magnetic read/write head of the present invention is structured so that such a distribution of amounts of expansion and constriction is asymmetric with respect the displacement axis on the surface at the trailing edge of the slider, which axis is perpendicular to the surface of the magnetic recording medium. This asymmetric distribution of amounts of expansion and constriction is referred to as asymmetrical displacement (deformation) of piezoelectric device in the present specification.

Further, in the magnetic read/write head of the present invention, the piezoelectric device and the magnetic read/write element are provided in this order on the surface at the trailing edge of the slider. When the piezoelectric device is displaced asymmetrically with respect to the displacement axis which is perpendicular to the surface of the magnetic recording medium and which is on the surface at the trailing edge of the slider, the magnetic read/write element contacting the piezoelectric device is moved by the piezoelectric device, and is rotated by a small angle about the rotation axis perpendicular to the magnetic recording medium. This enables the magnetic read/write head to perform highly accurate tracking with respect to a magnetic recording medium having highly densified data tracks.

The following describes the expression “trailing edge of the slider”. First, the slider is described. The surface of the slider 3 facing the magnetic recording medium has an irregular shape of sub micron to micron order, which is referred to as an ABS shape. This surface is referred to as ABS(Air Bearing Surface) of the slider. The ABS shape controls airflow between the magnetic recording medium and the slider, thereby enabling the slider to fly at a certain distance from the magnetic recording medium. An upstream edge of the ABS where the air stream flowing in between the ABS and the magnetic recording medium is referred to as “leading edge” and a downstream edge of the ABS where the air stream flowing out between the ABS and the magnetic recording medium is referred to as “trailing edge”. Further, the “surface at an trailing edge” is a side surface of the slider when the bottom surface is the ABS, and is perpendicular to the air stream between the ABS and the magnetic recording medium at the trailing edge. The “surface at an leading edge ” is another side surface of the slider, and is perpendicular to the air stream between the ABS and the magnetic recording medium at the leading edge.

The air flowing in between the ABS and the magnetic recording medium is compressed and generates a positive pressure to lift the slider above the magnetic recording medium. Then, the pressure of the air is varied as the air approaches the trailing edge of the ABS, thus enabling the entire slider to fly at an extremely short distance such as several 10 nm away from the magnetic recording medium.

The magnetic read/write head of the present invention may be adapted so that the piezoelectric device is formed by stacking a first electrode layer, a piezoelectric layer, and a second electrode layer in this order on the surface at the trailing edge of the slider; and the second electrode layer includes two electrodes which are an electrode A and an electrode B, the electrode A and the electrode B being arranged parallel to each other on the piezoelectric layer, and the magnetic read/write element is arranged so as to link the electrode A and the electrode B.

With this, it is possible to apply different voltages to the electrode A and the electrode B, respectively. In the piezoelectric layer below the two electrodes, the portion below the electrode A and the portion below the electrode B are displaced by different amounts respectively with the application of the different voltages. Thus, the piezoelectric device is easily displaced asymmetrically with respect to the displacement axis.

The electrode A and the electrode B are on the left and right sides of the displacement axis, and are parallel to each other and the displacement axis. For example, the electrode A is the electrode on the left of the displacement axis, when viewed towards the surface at the trailing edge, and the electrode B is the other electrode on the right. These electrode A and electrode B are preferably electrically insulated from the magnetic read/write element.

Further, the magnetic read/write element is arranged so as to link the electrode A and the electrode B. It is therefore possible to rotate the magnetic read/write element about the rotation axis by a small desired angle by utilizing the asymmetrical displacement of the piezoelectric device.

The expression “link the electrode A and the electrode B” means that two ends of the magnetic recording/reproducing element (the substrate having thereon the magnetic recording/reproducing element) contact the electrode A and the electrode B, respectively, so as to bridge the area between the electrode A and the electrode B.

The configuration having the piezoelectric device between the surface at the trailing edge and the magnetic read/write element allows rotation of the magnetic read/write element by a given small angle about the rotation axis. This enables the magnetic read/write head to perform highly accurate tracking even with respect to a magnetic recording medium having highly densified data tracks.

The magnetic read/write head may be adapted so that the piezoelectric layer of the piezoelectric device includes two piezoelectric layers which are a piezoelectric body A and a piezoelectric body B, the piezoelectric body A and the piezoelectric body B being arranged parallel to each other on the first electrode layer; and the electrode A is arranged on the piezoelectric body A and the electrode B is arranged on the piezoelectric body B.

In this structure, the piezoelectric layers are arranged independently of the other, below the electrode A and the electrode B, respectively. Thus, each of the two piezoelectric bodies A and B is able to expand or constrict without affecting the other piezoelectric body facing the other electrode. This enables accurate control of the telescopic driving of each of the piezoelectric bodies A and B, and also enables uniform telescopic drive of each piezoelectric body. Further, it is possible to eliminate element fatigue attributed to distributed expansion and constriction. Thus, a piezoelectric device with higher reliability and controllability is provided.

The piezoelectric body A and the piezoelectric body B are arranged on the first electrode layer. On the first electrode layer are a stack of the piezoelectric body A and the electrode A which are stacked in this order, and a stack of the piezoelectric body B and the electrode B which are stacked in this order. The piezoelectric body A and the piezoelectric body B are on the left and right of the displacement axis, and are parallel to each other and the displacement axis. For example, the piezoelectric body A is the piezoelectric body on the left of the displacement axis, when viewed towards the surface at the trailing edge, and the piezoelectric body B is the piezoelectric body on the right.

The magnetic read/write head of the present invention is preferably adapted so that the center of the magnetic read/write element in relation to a direction perpendicular to the displacement axis on the surface at the trailing edge is at the same position as the center of a line connecting the center of the electrode A and the center of the electrode B.

With this, when the two regions of the piezoelectric devices facing the electrodes A and B are displaced by the same amount in the positive and negative directions of the normal direction of the surface at the trailing edge, respectively, the magnetic read/write element rotates axial symmetrically, with respect to the center of the magnetic read/write element. This enables easier tracking control operation of the magnetic read/write head.

The expression “the center of the magnetic read/write element” means the center of the sensing element which is an element constituting the magnetic read/write element and which is a magnetic sensor for reading and reproducing signals from a magnetic field on a magnetic recording medium, or the center of the main magnetic pole of a magnetic field generating element which generates a recording magnetic field for writing in a magnetic recording medium. Alternatively, “the center of the magnetic read/write element” may be the center of other functional part which writes or senses a magnetic bit on a magnetic recording medium, in a read/write operation.

The magnetic read/write head of the present invention may be adapted so that the piezoelectric device includes two piezoelectric device elements which are a piezoelectric device element C and a piezoelectric device element D. Each of the piezoelectric device element C and the piezoelectric device element D may include a plurality of stacked piezoelectric layers, a plurality of first internal electrode layers and a plurality of second internal electrode layers each supported by at least one of the plurality of piezoelectric layers, the first internal electrode layers and the second electrode layers being formed alternately, and a first side surface electrode and a second side surface electrode respectively connected to the first internal electrode layers and the second internal electrode layers. Further, the piezoelectric device element C and the piezoelectric device element D may be arranged in parallel to each other on the surface at the trailing edge of the slider, and the magnetic read/write element may be arranged so as to link the piezoelectric device element C and the piezoelectric device element D.

In this structure, the piezoelectric device element has stacked structure in which the internal electrode layers and the piezoelectric layers for driving each piezoelectric device element are stacked. It is therefore possible to efficiently apply an electric field to each piezoelectric layer. Further, potentials of opposite polarities are respectively applied to the internal electrode layers facing one another via a piezoelectric layer. Thus, the stacked structure of the piezoelectric device elements is advantageous in that the force of the piezoelectric device elements for generating displacement is increased, the response speed is accelerated, and that the power consumption is reduced. Such a stacked structure preferably includes several tens or more of alternately stacked piezoelectric layers and internal electrode layers.

The following describes the piezoelectric device element C and the piezoelectric device element D. The piezoelectric device element C and the piezoelectric device element D are respectively arranged on the left and right of the displacement axis, and are parallel to each other and the displacement axis. For example, the piezoelectric device element C is the piezoelectric device element on the left of the displacement axis, when viewed towards the surface at the trailing edge, and the piezoelectric device element D is the piezoelectric device element on the right of the displacement axis.

With the magnetic read/write element linking the piezoelectric device element C and the piezoelectric device element D, it is possible to rotate the magnetic read/write element by a small desired angle about the rotation axis, by asymmetrically displacing the piezoelectric devices.

The expression “link the piezoelectric device element C and the piezoelectric device element D” means that two ends of the magnetic read/write element (the substrate having thereon the magnetic read/write element) contact the piezoelectric device element C and the piezoelectric device element D, respectively so as to bridge the area between the piezoelectric device element C and the piezoelectric device element D. The piezoelectric device element C, the piezoelectric device element D, and the magnetic read/write element are preferably electrically insulated from one another.

### BRIEF DESCRIPTION OF THE DRAWINGS

Other and further objects, features and advantages of the invention will appear more fully from the following description taken in connection with the accompanying drawings in which:

FIG. 1 is a side view of a magnetic read/write apparatus of an embodiment, according to the present invention.

FIG. 2 is a perspective view of the magnetic read/write head of the embodiment, according to the present invention.

FIG. 3 is a partial transverse cross sectional view of the magnetic read/write head illustrated in FIG. 2.

FIG. 4 is a perspective view illustrating the magnetic read/write head of FIG. 2 attached to a suspension.

FIG. 5 is a partial transverse cross sectional view illustrating an alternative form of the magnetic read/write head illustrated in FIG. 3, in which the piezoelectric device has been modified.

FIGS. 6A to 6E are perspective views illustrating sequentially the steps of a manufacturing method of the magnetic read/write head illustrated in FIG. 2.

FIGS. 7A to 7E are cross sectional views illustrating sequentially the sub steps of the steps illustrated in FIGS. 6A to 6E, for forming a plurality of first electrodes on a substrate.

FIGS. 8A to 8C are perspective views illustrating sequentially the steps of manufacturing method of the magnetic read/write head illustrated in FIG. 2, continued from the steps illustrated in FIGS. 6A to 6E.

FIGS. 9A and 9B are plane view illustrating a positional relationship between a data track and the magnetic read/write head in the magnetic read/write apparatus illustrated in FIG. 1.

### DESCRIPTION OF THE PREFERRED EMBODIMENTS

(Structure of Magnetic Read/Write Apparatus)

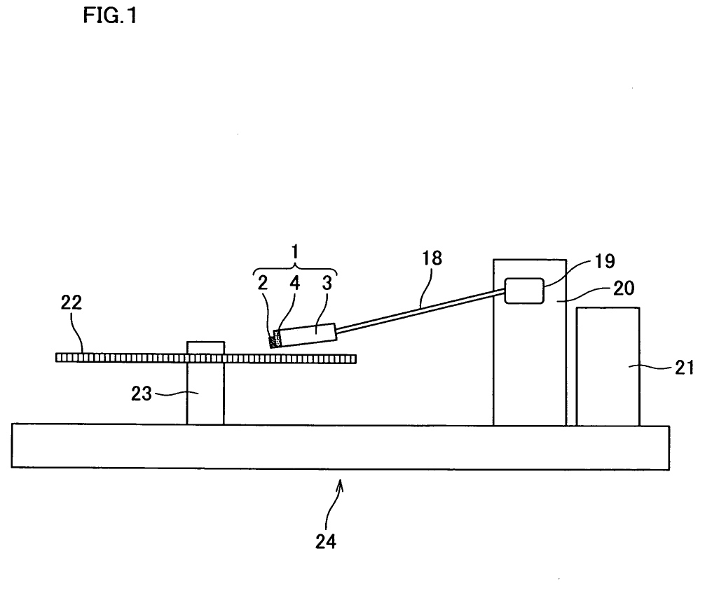

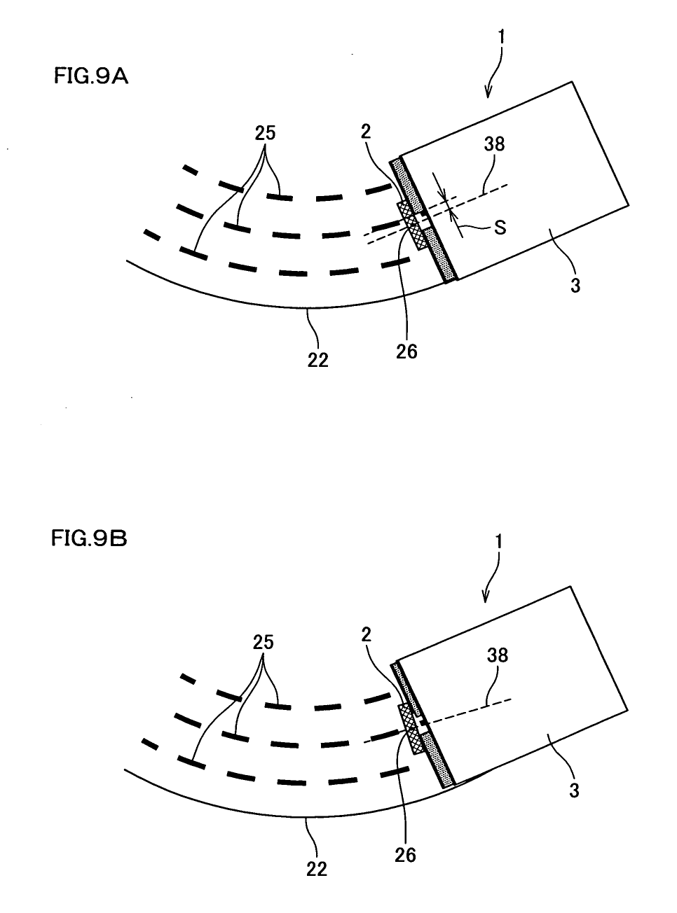

First, the following describes the structure of a magnetic read/write apparatus 24 of one embodiment, according to the present invention. The magnetic read/write apparatus 24 illustrated in FIG. 1 includes: a magnetic read/write head 1, a disk shaped magnetic recording medium 22, a magnetic recording medium drive unit 23, a support arm 18, a magnetic read/write head drive unit 20, and a read/write signal processing system 21. The magnetic read/write head 1 performs recording and reproduction of magnetized information as hereinafter detailed. On the magnetic recording medium 22, information is recorded in the form of magnetization direction. The magnetic recording medium drive unit 23 rotates the magnetic recording medium 22. The support arm supports the magnetic read/write head 1. On the top surface of the magnetic recording medium 22 are data tracks 25 (see FIG. 9A) formed in a circumferential direction about the center of the magnetic recording medium 22. In the magnetic read/write head drive unit 20 is arranged a voice coil motor (VCM) 19. The voice coil motor 19 activates the support arm 18 to move the magnetic read/write head 1 to a desired position of the magnetic recording medium 22.

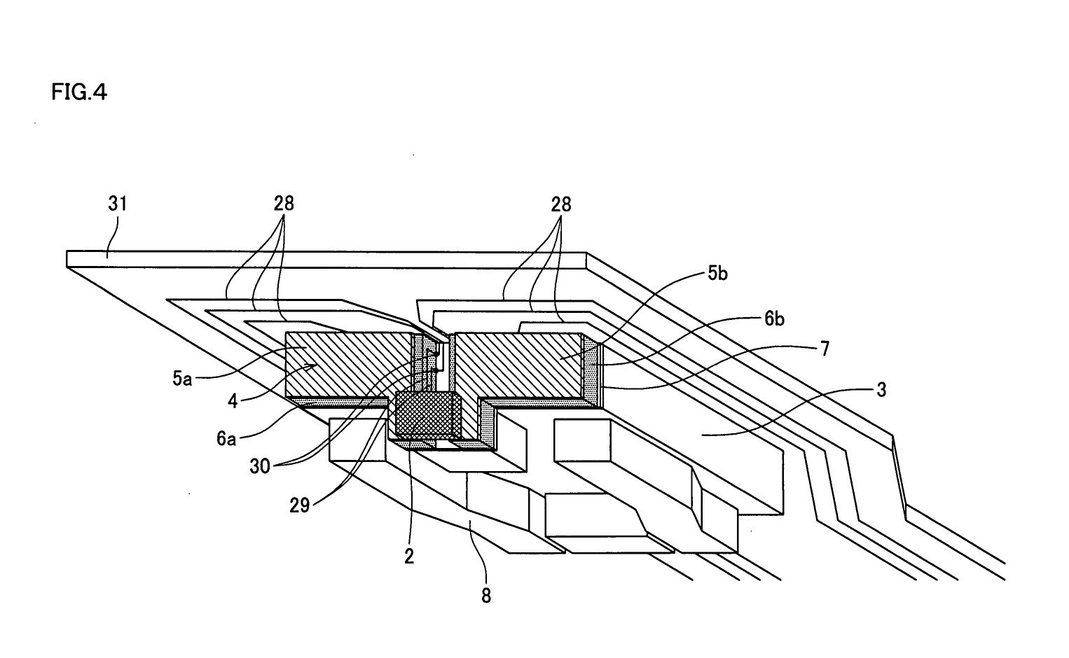

The support arm 18 has a suspension 31 (see FIG. 4) and a swing arm (not shown). This support arm 18 supports the magnetic read/write head 1 and moves the same to a desired position.

The suspension 31 has two components, a load beam (not shown) and a gimbal (not shown). The load beam generates a certain weight on the slider 3 to ensure flying stability. The gimbal is a spring-like component which absorbs side-runout of the magnetic recording medium 22 and tilt associated with the assembly of the magnetic read/write head 1, and which enables highly accurate tracking of data tracks 25. With the structure, the magnetic read/write head 1 fixed on the slider 3 is able to fly above the rotating magnetic recording medium 22.

The swing arm is driven in conjunction with the VCM 19. This swing arm, which moves the suspension 31 and the magnetic read/write head 1 mounted on the leading end of the swing arm to a position of a desired data track 25, enables positioning of the magnetic read/write head 1 relative to the data track 25.

The VCM 19 generates a drive force for driving the support arm 18. This VCM 19 enables highly accurate positioning of the magnetic read/write head 1 to a desired position of the magnetic recording medium 22.

(Schematic Structure of Magnetic Read/Write Head)

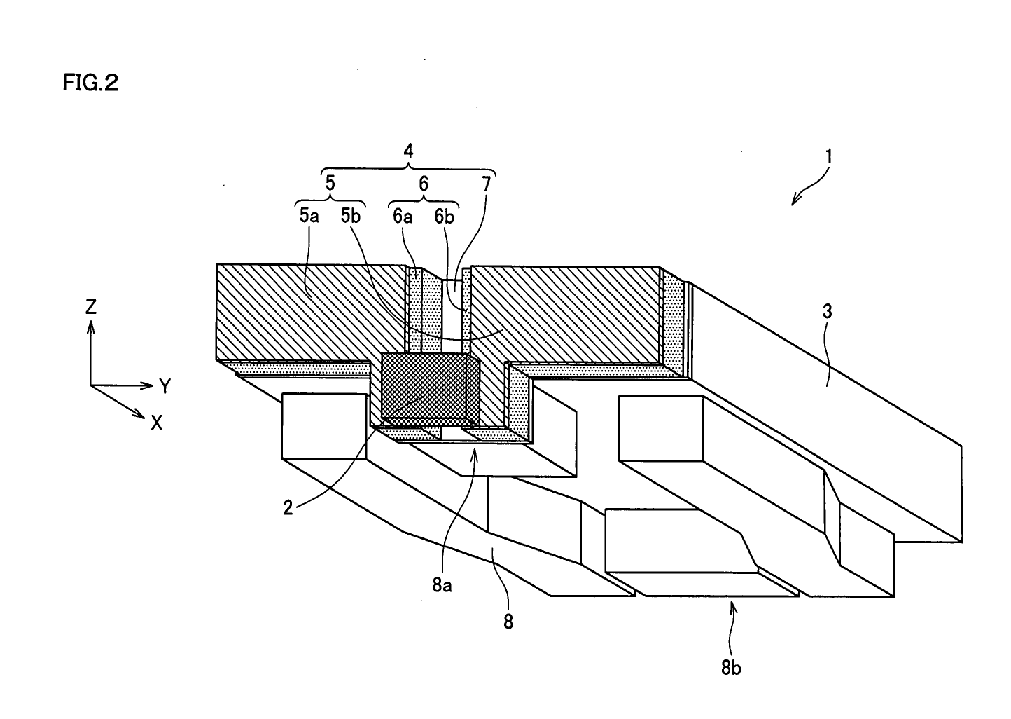

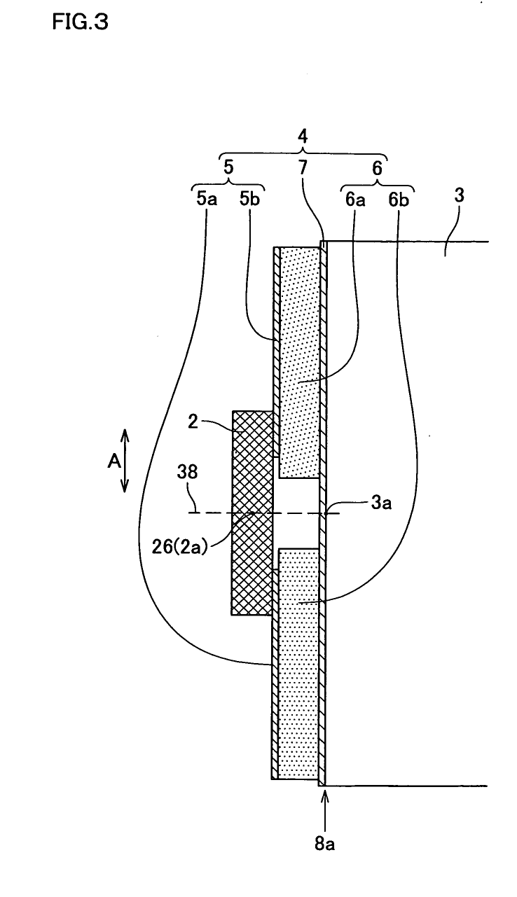

Next, with further reference to FIGS. 2 and 3, the following describes a schematic structure of the magnetic read/write head 1.

The magnetic read/write head 1 has a slider 3 as illustrated in FIG. 2. The under surface of the slider 3 is an air bearing surface (ABS) 8. The slider 3 has an trailing edge 8a and an leading edge 8b which are formed along the longer direction of the slider 3 so as to face each other. Due to the irregularity on the ABS 8, the surface at the trailing edge 8a of the slider 3 (a side surface of the slider 3) is in a T-shape. On this surface at the trailing edge 8a of the slider 3 is arranged a T-shaped piezoelectric device 4. Further, the piezoelectric device 4 is provided with a magnetic read/write element 2 arranged at the root of the T-shape, that is, at a portion extending in the up/down direction in FIG. 2. Note that FIG. 3 is a partial transverse cross sectional view of the magnetic read/write head 1 at the root of the T-shape.

As hereinafter detailed, the piezoelectric device 4 is capable of selectively generating a symmetric or asymmetrical displacement, upon application of voltage, with respect to a displacement axis 3a on the surface at the trailing edge 8a of the slider 3, which axis is perpendicular to the surface of the magnetic recording medium 22, (or a plane 38 passing displacement axis 3a which is perpendicular to the both the surface of the magnetic recording medium 22 and the surface at the trailing edge 8a of the slider 3). Then, the magnetic read/write element 2 rotates and/or moves in parallel, according to the displacement of the piezoelectric device 4.

The displacement axis 3a is on the surface at the trailing edge 8a of the slider 3, and extends in a direction perpendicular to the sheet of FIG. 3. As is understood from FIG. 1, the displacement axis 3a is substantially perpendicular to the surface of the magnetic recording medium 22.

(Mounting of Magnetic Read/Write Head to Suspension)

As illustrated in FIG. 4, in the magnetic read/write apparatus 24 of the present embodiment, the suspension 31 has on its under surface a plurality of wires 28 for electrically performing transmission/reception to/from the magnetic read/write head 1. These wires 28 are for communicating read/write signals to the magnetic read/write element 2 and control signals for driving the piezoelectric device 4. Each wire 28 is connected to the read/write signal transmission/reception wire 29 provided on the magnetic read/write head 2 (more specifically, to inner side surfaces of a later-mentioned piezoelectric body 6a and a piezoelectric body 6b), via an elastic component 30. Note that FIG. 4 only illustrates the read/write signal transmission/reception wires 29 and the elastic components 30 of only two wires 28 out of six wires 28. Further, although detailed illustration is omitted in FIG. 4, the shape of a later-mentioned first electrode layer 7 is designed so as to avoid any trouble in the connection between the wire 28 and the read/write signal transmission/reception wire 29. Each elastic component 30 may be a component made of conductive polymers having rubber elasticity, for example.

As described, the wire 28 and the read/write signal transmission/reception wire 29 are connected to each other via the elastic component 30. Therefore, even when the connection point moves due to the telescopic driving of the piezoelectric device 4, the wire 28 and the read/write signal transmission/reception wire 29 are hardly disconnected. Thus, a stable driving of the piezoelectric device 4 is ensured.

(Slider)

Return to FIGS. 2 and 3 now. The magnetic read/write element 2 is mounted to the slider 3, via the piezoelectric device 4. The slider 3 provides support for the magnetic read/write element 2 to fly above the magnetic recording medium 22. The ABS 8 of the slider 3 has an irregular shape of sub micron to micron order, which is referred to as an ABS shape. This irregular shape is optimized to control a flow of air and generated pressure, thus enabling the slider 3 to stably fly above the magnetic recording medium 22. As the material of such a slider 3 is adopted AlTiC (Al₂O₃—TiC) sintered compact. Needless to say that other materials are also adoptable as the material of the slider 3.

(Piezoelectric Device)

As illustrated in FIGS. 2 and 3, piezoelectric device 4 is formed by stacking a first electrode layer 7, a piezoelectric layer 6, and a second electrode layer 5 in this order on the surface at the trailing edge 8a of the slider 3. The first electrode layer 7 is formed in a T-shape and is on the surface at the trailing edge 8a of the slider 3.

The second electrode layer 5 includes two electrodes: an electrode 5a (electrode A) and an electrode 5b (electrode B). These electrodes are insulated from each other and have a substantially L-shape which partially extends to the root portion of the T-shape. The piezoelectric layer 6 includes two piezoelectric bodies: a piezoelectric body 6a (piezoelectric body A) and a piezoelectric body 6b (piezoelectric body B). Each of these piezoelectric bodies has a substantially L-shape which partially extends to the root portion of the T-shape. The piezoelectric bodies 6a and 6b are arranged in parallel, on the first electrode layer 7. On the piezoelectric body 6a is arranged the electrode 5a, and on the piezoelectric body 6b is arranged the electrode 5b. The electrodes 5a and 5b therefore are arranged in parallel, on the piezoelectric layer 6.

The electrode 5a and the piezoelectric body 6a, and the electrode 5b and the piezoelectric body 6b are line-symmetrical with respect to the plane 38. The electrodes 5a and 5b have the same shape and the same thickness, and are made of the same material. Likewise, the piezoelectric bodies 6a and 6b have the same shape and the same thickness, and are made of the same material. However, alternatively, the piezoelectric bodies 6a and 6b may be made of materials whose piezoelectric constants are different. In such a case, even when voltage applied to the electrode 5a is the same as that applied to the electrode 5b, the amount of displacement of the piezoelectric body 6a is different from the amount of displacement of the piezoelectric body 6b.

The first electrode layer 7 and the second electrode layer 5 (the electrodes 5a and 5b) are both made of aluminum (Al). As the material of the piezoelectric layer (the piezoelectric bodies 6a and 6b) is adopted lead zirconate titanate (PZT). However, the material of the piezoelectric device 4 is not limited to this provided that the function of the piezoelectric device 4 is achieved. For example, as the material of the first electrode layer 7 and the second electrode layer 5 (the electrodes 5a and 5b), a highly conductive material such as gold (Au), copper (Cu), platinum (Pt), or the like may be adopted. Further, as the material of the piezoelectric layer 6 (the piezoelectric bodies 6a and 6b), materials with a high piezoelectric constant, such as aluminum nitride (AlN), zinc oxide (ZnO) or the like may be adopted.

When different voltages are applied to the electrodes 5a and 5b respectively, the piezoelectric bodies 6a and 6b below the two electrodes respectively represent different amounts of displacement in the thickness direction. Thus, an asymmetrical displacement of the piezoelectric device 4 with respect to the displacement axis 3a or the plane 38 is easily generated.

When the same voltage is applied to the electrode 5a and 5b, the piezoelectric bodies 6a and 6b below the two electrodes represent the same amount of displacement in the thickness direction. Thus, a symmetrical displacement of the piezoelectric device 4 with respect to the displacement axis 3a or the plane 38 is easily generated.

Further, the both of the piezoelectric bodies 6a and 6b are independent of each other below the electrodes 5a and 5b, respectively. Each piezoelectric body therefore is able to expand or constrict, without influence of expansion or constriction of the other piezoelectric body. This enables more accurate control of telescopic driving of the piezoelectric bodies 6a and 6b. Further, since uniform expansion and constriction within each of the piezoelectric bodies 6a and 6b are possible, there will be no element fatigue due to the stress attributed to distribution of expansion or constriction. Thus, there is provided a piezoelectric device 4 with a higher reliability and a better controllability.

Note that the piezoelectric layer 6 of the present embodiment includes two piezoelectric bodies: the piezoelectric body 6a and the piezoelectric body 6b. However, the piezoelectric layer 6 may include only one piezoelectric body or three or more piezoelectric bodies parallel to each other. In either cases, the voltage to be applied to the piezoelectric devices 4 needs to be distributed in such a manner as to displace the piezoelectric device 4 asymmetrically with respect to the displacement axis 3a. For example, application of voltage is distributed by forming the first electrode layer 7 and/or second electrode layer 5 to include a plurality of electrodes, and varying the voltage to be applied to the electrodes. Further, in the present embodiment, the second electrode layer 5 includes the electrode 5a and the electrode 5b. However, the second electrode layer 5 may include a single electrode or three or more electrodes parallel to one another. Further, the first electrode layer 7 may include a plurality of electrodes arranged in parallel.

The piezoelectric device 4 is provided between the magnetic read/write element 2 and the slider 3. The piezoelectric device 4, the magnetic read/write element 2, and the slider 3 are insulated from one another by a not-shown SiN insulation film. An insulative material other than the SiN insulation film may be also adopted for insulating these components.

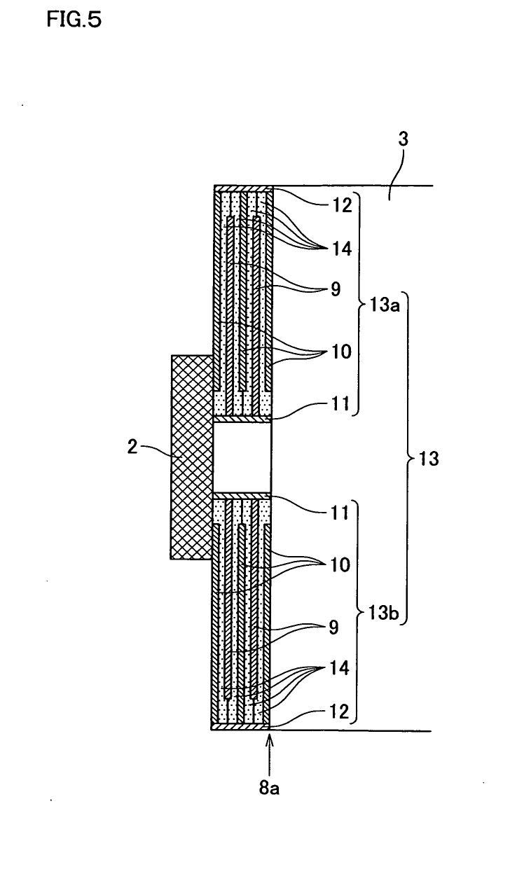

The following describes with reference to FIG. 5, an alternative form of the piezoelectric device. As illustrated in FIG. 5, an alternative form of the piezoelectric device 13 includes two piezoelectric device elements: a piezoelectric device element 13a (piezoelectric device element C) and a piezoelectric device element 13b (piezoelectric device element D). Each of the piezoelectric device elements 13a and 13b includes: a plurality of piezoelectric layers 14 (four layers in FIG. 5) stacked on one another; a plurality of first internal electrode layers 9 (two layers in FIG. 5); a plurality of second internal electrode layers 10 (three layers in FIG. 5); a first side surface electrode 11; and a second side surface electrode 12. Each of the first internal electrode layers 9 and the second internal electrode layers 10 is supported by at least one of the piezoelectric layers 14. These first and second internal electrode layers 9 and 10 are alternately arranged so that each layer reaches one of the left or right end of the piezoelectric layer 14. The first side surface electrode 11 and the second side surface electrode 12 covers the side surfaces of the piezoelectric layers 14 and are respectively connected to the first internal electrode layers 9 and the second internal electrode layers 10. To the first internal electrode layers 9 and the second internal electrode layers 10 facing one another via the piezoelectric layers 14, potentials of opposite polarities are applied via the first side surface electrode 11 and the second side surface electrode 12, respectively.

As is understood from the above, each of the piezoelectric device elements 13a and 13b has a stack of internal electrode layers 9 and 10 and the piezoelectric layers 14 for driving the piezoelectric device elements, thus enabling efficient application of an electric field to the piezoelectric layers 14. Further, potentials of opposite polarities are respectively applied to the internal electrode layers 9 and the internal electrode layers 10 facing one another via a piezoelectric layer 14. Thus, the stacked structure of the piezoelectric device elements 13a and 13b is advantageous in that the force of the piezoelectric device elements 13a and 13b for generating displacement is increased, the response speed is accelerated, and that the power consumption is reduced.

Such a stacked structure preferably includes several tens or more of alternately stacked piezoelectric layers 14 and electrodes (the first internal electrode layers 9 and the second internal electrode layers 10).

As illustrated in FIG. 5, the piezoelectric device elements 13a and 13b are arranged parallel to each other, on the surface of the slider 3 on the side of the trailing edge. On these piezoelectric device element 13a and 13b, the magnetic read/write element 2 is arranged so as to link the piezoelectric device elements 13a and 13B.

(Magnetic Read/Write Element)

The magnetic read/write element 2 includes: a recording magnetic field generating element (not shown) which generates a recording magnetic field for recording magnetized information on the magnetic recording medium 22; and a magnetic reproduction element (not shown) which reproduces magnetized information recorded on the magnetic recording medium 22. For example, the recording magnetic field generating element may be a magnetic coil element, and the magnetic reproduction element may be a magnetoresistive effect element. The resistance value of the magnetoresistive effect element varies according to the leak magnetic field from the magnetic recording medium 22. Sensing of the leak magnetic field therefore is possible by means of supplying current to the magnetoresistive effect element.

The magnetic read/write element 2 is not particularly limited to the above element provided that information is written in or read out from the magnetic recording medium 22.

(Positional Relationship between Magnetic Read/Write Element and Piezoelectric Device)

The following describes the positional relationship between the magnetic read/write element 2 and the piezoelectric device 4. As illustrated in FIG. 3, the magnetic read/write element 2 is arranged so as to link the electrode 5a and the electrode 5b. Further, in relation to the directions perpendicular to the displacement axis 3a on the surface of the side of the trailing edge 8a (directions indicated by arrow-A in FIG. 3), the center 26 of the magnetic read/write element 2 is at the same position as the center of the line connecting the centers of the electrodes 5a and 5b. Note that, in the present embodiment, the plane 38 along with the displacement axis 3a extends through the center 26.

The present embodiment deals with a case where the magnetic read/write element 2 is arranged on the piezoelectric device 4. Therefore, voltage application to generate an asymmetrical displacement of the piezoelectric device 4 with respect to the displacement axis 3a rotates the magnetic read/write element 2 by any given small angle about the axis (hereinafter, “rotation axis”) perpendicular to the surface of the magnetic recording medium 22. This allows the magnetic read/write head 1 to perform highly accurate tracking with respect to the magnetic recording medium 22 having highly densified data tracks 25. Further, voltage application to generate a symmetrical displacement of the piezoelectric device 4 with respect to the displacement axis 3a displaces the magnetic read/write element 2 by a given slight distance in a direction perpendicular to the surface at the trailing edge 8a. Further, the simple structure of the magnetic read/write head 1, in which the piezoelectric device 4 is interposed between the slider 3 and the magnetic read/write element 2, is advantageous in terms of productivity.

Note that tracking means moving the magnetic read/write head 1 to a desired data track 25 of the magnetic recording medium 22, and adjusting the position of the center 26 of the magnetic read/write element 2 to the center position of the data track 25, when recording or reproducing information.

The rotation angle of the magnetic read/write element 2 about the rotation axis 2a depends on the asymmetrical displacement of the piezoelectric device 4. More specifically, rotation angle is greater when the absolute value of the difference in the amounts of displacement, on the left and right sides of the plane 38, in the normal direction of the surface at the trailing edge 8a. The present embodiment is adapted so that, the amounts of displacement in the positive or negative direction in the normal direction of the surface at the trailing edge 8a are the same on the left and right sides of the plane 38. This simplifies control of the piezoelectric device 4.

In the present embodiment, the rotation axis 2a is parallel to the displacement axis 3a, and extends across the center 26 of the magnetic read/write element 2. This is attributed to the following reasons. (a) In relation to the direction indicated by the arrow-A, the center 26 of the magnetic read/write element 2 is at the same position as the center of the line extending from the center of the electrode 5a and that of the electrode 5b. (b) When rotating the magnetic read/write element 2, the piezoelectric body 6a on one side of the plane 38 is thickened while thinning, by the same amount the piezoelectric body 6a is thickened, the piezoelectric body 6b on the other side of the plane 38. In other words, the position of the rotation axis 2a is determined according to the positional relationship between the center 26 of the magnetic read/write element 2 and the two electrodes 5a and 5b, in relation to the direction indicated by the arrow-A, and the amount of displacement of the piezoelectric bodies 6a and 6b on the left and right sides. Accordingly, the rotation axis 2a does not necessarily have to match with the center 26 of the magnetic read/write element 2, and may be in any position provided that the rotation axis 2a is perpendicular to the surface of the magnetic recording medium 22. For example, the rotation axis 2a may be set outside the magnetic read/write element 2.

Further, in the magnetic read/write head 1 of the present embodiment, the piezoelectric device 4 has a symmetrical structure with respect to the displacement axis 3a. Therefore, application of voltage symmetrically with respect to the displacement axis 3a will generate symmetrical displacement with respect to the displacement axis 3a or the plane 38. On the contrary, when voltage is applied to the piezoelectric device 4 asymmetrically with respect to the displacement axis 3a, an asymmetrical displacement with respect to the displacement axis 3a or the plane 38 is generated. The symmetrical displacement of the piezoelectric device 4 displaces the magnetic read/write element 2 perpendicularly to the surface at the trailing edge 8a of the slider 3. The asymmetrical displacement of the piezoelectric device 4 rotates the magnetic read/write element 2 about the center of the rotation axis 2a.

As is understood from the above, the piezoelectric device 4 is displaced symmetrically or asymmetrically with respect to the displacement axis 3a, through application of voltage. Accordingly, it is possible to selectively perform moving of the magnetic read/write element 2 in parallel to the direction perpendicular to the surface at the trailing edge 8a of the slider 3, or rotating the magnetic read/write element 2 about the rotation axis 2a. It is further possible to perform the moving and rotating in combination.

In the present embodiment, a symmetrical displacement is achieved by thickening or thinning by the same amount the piezoelectric device 4 on both sides of the plane 38 which is perpendicular to both the surface of the magnetic recording medium 22 and the surface of the slider 3 on the side of the trailing edge 8 and which crosses the displacement axis 3a. This simplifies controlling of the piezoelectric device 4 at a time of generating a symmetrical displacement.

In the present embodiment, an asymmetrical displacement is achieved by thickening the piezoelectric device 4 on one side of the plane 38, while thinning the piezoelectric device 4 on the other side of the plane 38. This simplifies controlling of the piezoelectric device 4 at a time of generating an asymmetrical displacement.

Further, the present embodiment deals with a case where the center 26 of the magnetic read/write element 2 is at the same position as the center of the line connecting the centers of the electrodes 5a and 5b in relation to the direction indicated by the arrow-A. Thus, when the two regions of the piezoelectric devices 4 facing the electrodes 5a and 5b are displaced by the same amount in the positive and negative directions of the normal direction of the surface at the trailing edge 8a, respectively, the magnetic read/write element 2 rotates axial symmetrically, with respect to the center 26 of the magnetic read/write element 2. This enables easier tracking control operation of the magnetic read/write head 1.

The same effect is brought about with the alternative form illustrated in FIG. 5. Thus, when the two piezoelectric device element 13a and 13b are displaced by the same amount in the positive and negative directions of the normal direction of the surface at the trailing edge 8a, respectively, the magnetic read/write element 2 rotates axial symmetrically, with respect to the center 26 of the magnetic read/write element 2. This enables easier tracking control operation of the magnetic read/write head 1.

Further, in the magnetic read/write apparatus of the present embodiment, tracking control is performed in two stages; a tracking control at the voice coil motor 19 and a tracking control at the piezoelectric device 4. This enables a highly accurate positioning of the magnetic read/write head 1, even if the track pitch is reduced due to an increase in the density of data tracks.

Note that the positional relationship of the magnetic read/write element 2 to the piezoelectric device 4 is not limited to the one in the magnetic read/write head 1 of the present embodiment described above, and various positional relationships of these elements are possible within the scope of the present invention.

(Manufacturing Method of Magnetic Read/Write Head of the Present Invention)

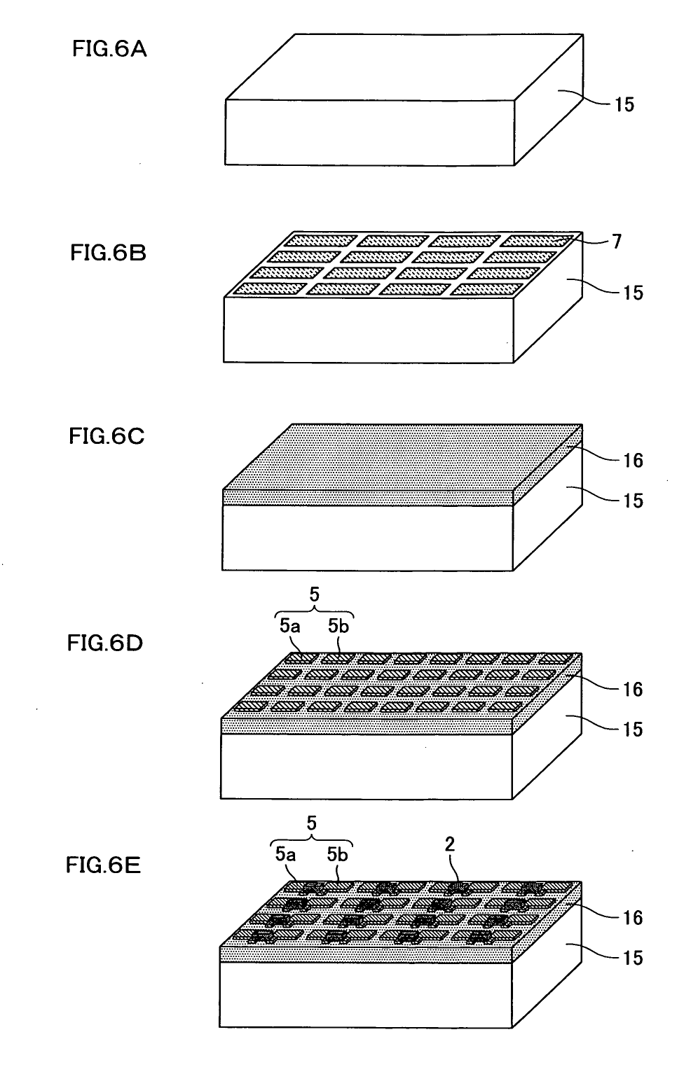

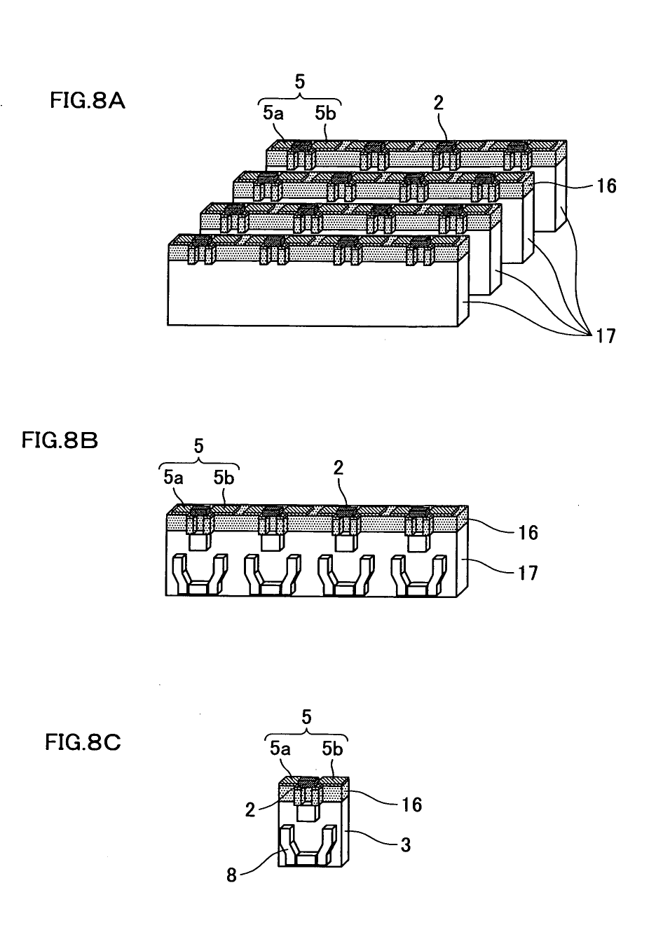

The following describes a manufacturing method of the magnetic read/write head 1 of the present embodiment with reference to FIGS. 6A to 6E, and FIGS. 8A to 8C.

First, as illustrated in FIG. 6A, an SiN insulation film (not shown) is formed on the surface of the substrate 15 made of Al₂O₃—TiC (AlTiC) sintered compact, by using a p-CVD apparatus. Next, as illustrated in FIG. 6B, a plurality of first electrodes layer 7 for the piezoelectric devices 4 are formed on the substrate 15 so as to sandwich therebetween the SiN insulation film. The first electrode layers 7 are arrayed in a two-dimensional matrix.

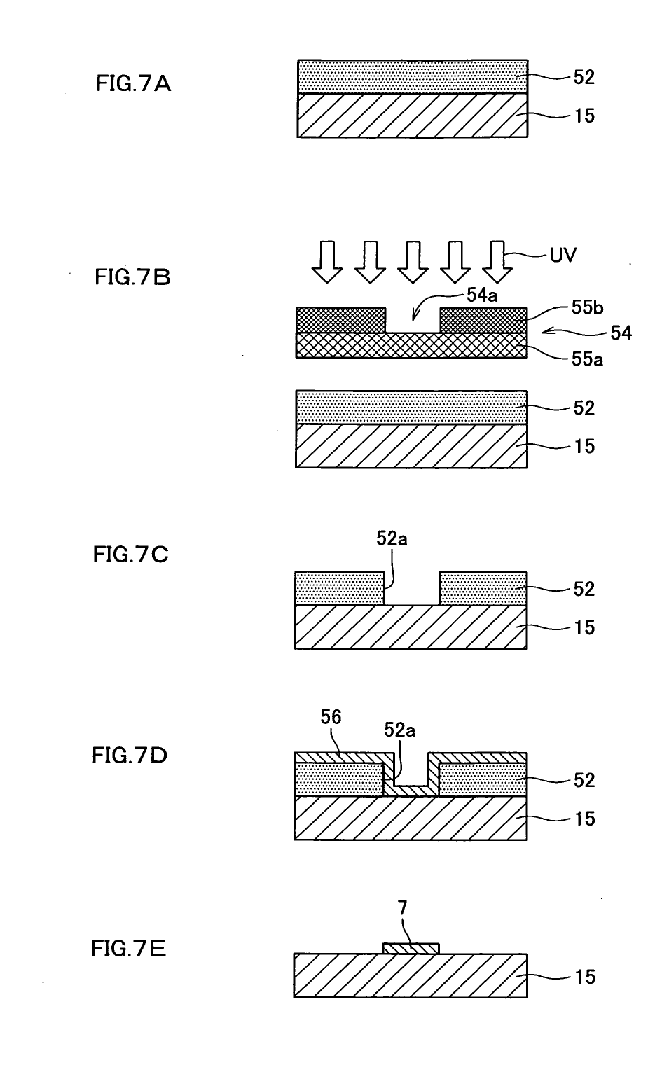

The following provides details of the above step of forming the plurality of first electrode layers 7 on the substrate 15, with reference to FIGS. 7A to 7E. Note that in FIGS. 7A to 7E omits illustration of the SiN insulation film. First, as illustrated in FIG. 7A, the substrate 15 is covered with a positive type resist layer 52. Then, as illustrated in FIG. 7B, a mask 54 having thereon an opening pattern 54a having identical shape to that of the first electrode layers 7 is placed in a desired position on the resist layer 52. The mask 54 is made by forming, on a silica glass 55a, a chrome (Cr) film 55b capable of blocking light. The chrome film 55b has a through hole to become an opening pattern 54a. Then, an ultraviolet ray is applied to the resist layer 52, via the opening pattern 54a of the mask 54. This exposes a region of the resist layer 52 to the ultraviolet ray UV, making the region of the resist layer 52 more soluble in a development solution. Thus, through a developing process, a through hole 52a having the identical shape to the opening pattern 54a of the resist layer 52 is formed as illustrated in FIG. 7C.

Next, as illustrated in FIG. 7D, using the electron beam evaporation technique, a conductive film (aluminum (Al) film) 56 is formed on the top surface of the resist layer 52, a side surface facing the through hole 52a, and the substrate 15 exposed on the bottom surface of the through hole 52a. Then, the resist layer 52 is peeled together with the conductive film 56 formed on the top surface and the side surface. The remaining conductive film 56 on the substrate 15 forms a first electrode layer 7, as illustrated in FIG. 7E. Note that the description here deals with a case where only one first electrode layer 7 is formed. A plurality of first electrode layer 7 can be formed by using a mask 54 having thereon a plurality of opening patterns 54a aligned identically to the alignment pattern of the plurality of first electrode layers 7.

Next, as illustrated in FIG. 6C, a piezoelectric material layer 16 made of a lead zirconate titanate (PZT) is formed by spattering so as to cover the entire pattern of the plurality of first electrode layers 7.

Then, through a process similar to formation of the first electrode layer 7, the second electrode layer 5 for the piezoelectric devices 4 made of an aluminum (Al) film is patterned through a photo lithography process or the like on the piezoelectric material layer 16, as illustrated in FIG. 6D. The second electrode layer 5 includes two electrode; an electrode 5a and an electrode 5b. After formation of the second electrode layer 5, an SiN insulation film is formed on the second electrode layer 5 with a p-CVD apparatus.

After that, to make electrical connection between the first electrode layer 7 and the second electrode layer 8, a pattern for etching a part of the piezoelectric material layer 16 is formed through a photo lithography process using a photoresist, and the part of the piezoelectric material layer 16 is removed by etching using an RIE etching device. Thus, a part of surfaces (not shown) of the first electrode layer 7 and the second electrode layer 5 are exposed.

Subsequently, as illustrated in FIG. 6E, the magnetic read/write element 2 is arranged on the surface of each piezoelectric device 4. At this time, the magnetic read/write element 2 is arranged in relation to the direction indicated by the arrow-A of FIG. 3 so that the center 26 of the magnetic read/write element 2 is at the same position as the center of the line connecting the centers of the electrodes 5a and 5b.

As illustrated in FIG. 8A, the resulting product of the step of FIG. 6E is then cut into a plurality of AlTiC bars 17 so that each bar has a single array of magnetic read/write elements 2, aligned in a direction connecting the electrodes 5a and 5b. Examples of cutting method at this time includes dicing, chemical etching, or physical etching. In cases of chemical etching or physical etching, a part which is not to be subjected to etching needs to be protected by a resist using a photo lithography.

Next, the cut surface of each AlTiC bar 17 cut out is processed into an ABS 8. Specifically, the surface to be subjected to the processing is fine-polished using an almina abrasives, CMP (Chemical-Mechanical Polishing) or the like. The surface is polished until the average surface roughness is in the order of several nanometers.

After that, as illustrated in FIG. 8B, the surface being subjected to the processing into the ABS 8 is patterned through a photo lithography, and formed into ABS 8 through an ion milling method.

Next, as illustrated in FIG. 8C, a dicing device is used to cut the AlTiC bar 17 in a direction perpendicular to the direction in which each bar is cut out in the stage illustrated in FIG. 8A, thus completing manufacturing of the magnetic read/write head 1.

(Control Method for Positioning Magnetic Read/Write Apparatus when Recording or Reproducing Information)

Next, the following describes, with reference to FIG. 1, FIG. 9A, and FIG. 9B, a tracking control method of the magnetic read/write apparatus 24.

As illustrated in FIG. 1, the magnetic read/write apparatus 24 has a two staged tracking control mechanism: one of which is at the VCM 19, and the other at the piezoelectric device 4. The VCM 19 moves the magnetic read/write head 1 to the data track 25, and the piezoelectric device 4 performs fine-adjustment of the position of the magnetic read/write head 1 above the data track 25.

The position of the magnetic read/write head 1 above the magnetic recording medium 22 is controlled as follows. First, servo information written in a predetermined position of the magnetic recording medium 22 is read out by the magnetic read/write head 1. The servo information is then analyzed by a magnetic read/write signal processing system 21. Then, a signal is transmitted to the magnetic read/write head drive unit 20, and the support arm 18 is driven by the voice coil motor 19 so as to move the magnetic read/write head 1 to a desired data track 25.

Subsequently, the servo information written in the data track 25 is read out by the magnetic read/write head 1 having reached the desired data track 25. The servo information read out is then analyzed by the magnetic read/write signal processing system 21 to derive a displacement amount S, in the radial direction, of the center 26 of the magnetic read/write element 2 from the center of the desired data track 25, as illustrated in FIG. 9A. From the displacement amount S, a required movement distance (rotation angle) of the magnetic read/write element 2 is calculated, and a signal indicative of the required movement distance (rotation angle) is transmitted to the magnetic read/write head drive unit to drive the piezoelectric device 4. As the result, the magnetic read/write element 2 rotates about the rotation axis 2a, and the center 26 of the magnetic read/write element 2 matches with the center of the desired data track 25, as illustrated in FIG. 9B.

While the VCM 19 moves the support arm 18 in a radial direction of the magnetic recording medium 22 to move the magnetic read/write element 2 in parallel, the piezoelectric device 4 generates an asymmetrical displacement with respect to the displacement axis 3a to rotate the magnetic read/write element 2 about the center of the rotation axis 2a by a slight angle, as illustrated in FIGS. 9A and 9B. Further, application of the same voltage to the electrodes 5a and 5b enables a slight movement of the piezoelectric device 4 in the axial direction of the support arm 18, while keeping the piezoelectric device 4 parallel to the surface at the trailing edge 8a of the slider 3. Additionally, it is possible to move the position of the magnetic read/write element 2, in combination with the slight rotation and the slight movement in the axial direction. Repeating this operation at the time of recording or reproducing magnetized information enables the magnetic read/write head 1 to follow a desired data track 25.

In the following description, the operation of positioning the magnetic read/write head 1 by moving the same using the VCM 19 is referred to as “coarse positioning operation”, and the operation of positioning the magnetic read/write element 2 by moving the same using the piezoelectric device 4 is referred to as “fine positioning operation”.

As hereinabove mentioned, the “coarse positioning operation” is performed for positioning the magnetic read/write element 2 above a desired data track 25. When the magnetic read/write element 2 reaches the data track 25, the “fine positioning operation” is performed to position the center 26 of the magnetic read/write element 2 above the center of the data track 25.

The positioning mechanism illustrated in FIG. 1 allows highly accurate tracking even in cases of the magnetic recording medium 22 having highly densified data tracks 25. The mechanism also realizes a magnetic read/write apparatus 24 which is more advantageous in terms of productivity. Dividing the positioning operation into steps, the tracking control method of the magnetic read/write apparatus 24 selectively utilizes the characteristics of the above described mechanisms in each of the positioning steps; e.g., using the VCM 19 for the “coarse positioning operation”, and using the piezoelectric device 4 for the “fine positioning operation”.

The VCM 19 and the piezoelectric device 4 are separately used in positioning operations, as hereinabove mentioned. However, the two elements (VCM 19 and the piezoelectric device 4) may be used in the “fine positioning operation”. This enables the magnetic read/write element 2 to move more freely above the magnetic recording medium 22, and even easier tracking of a desired data track 25 is possible.

In the above mentioned embodiment, the first electrode layer 7 may include two or more layers. Note that the magnetic read/write head of the present invention has a displacement axis which is perpendicular to the surface of the magnetic recording medium and which is on the surface of the slider at the trailing edge. However, the present invention encompasses a magnetic read/write head whose displacement axis is slightly tilted from the perpendicular direction to the magnetic recording medium, as is mentioned in the above embodiment.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A magnetic read/write head, comprising:
a slider having an ABS facing a magnetic recording medium, a surface perpendicular to an air stream at a leading edge where air flows in a space between the ABS and the magnetic recording medium, and a surface perpendicular to the air stream at a trailing edge where air flows out from the space between the ABS and the magnetic recording medium;
a piezoelectric device arranged on the surface of the trailing edge of the slider, which is, upon application of voltage, displaced asymmetrically with respect to a displacement axis on the surface at the trailing edge of the slider, the displacement axis being perpendicular to the surface of the magnetic recording medium; and
a magnetic read/write element arranged on the piezoelectric device, which rotates about a rotation axis perpendicular to the surface of the magnetic recording medium with the asymmetrical displacement of the piezoelectric device.

2. The magnetic read/write head, according to claim 1, wherein:
the piezoelectric device is formed by stacking a first electrode layer, a piezoelectric layer, and a second electrode layer in this order on the surface at the trailing edge of the slider; and
the second electrode layer includes two electrodes which are an electrode A and an electrode B, the electrode A and the electrode B being arranged parallel to each other on the piezoelectric layer, and the magnetic read/write element is arranged so as to link the electrode A and the electrode B.

3. The magnetic read/write head according to claim 2, wherein:
the piezoelectric layer of the piezoelectric device includes two piezoelectric bodies which are a piezoelectric body A and a piezoelectric body B, the piezoelectric body A and the piezoelectric body B being arranged parallel to each other on the first electrode layer; and
the electrode A is arranged on the piezoelectric body A, and the electrode B is arranged on the piezoelectric body B.

4. The magnetic read/write head according to claim 2, wherein
the center of the magnetic read/write element in relation to a direction perpendicular to the displacement axis on the surface at the trailing edge is at the same position as the center of a line connecting the center of the electrode A and the center of the electrode B.

5. The magnetic read/write head according to claim 1, wherein:
the piezoelectric device includes two piezoelectric device elements which are a piezoelectric device element C and a piezoelectric device element D;
each of the piezoelectric device element C and the piezoelectric device element D includes a plurality of stacked piezoelectric layers,
a plurality of first internal electrode layers and a plurality of second internal electrode layers each supported by at least one of the plurality of piezoelectric layers, the first internal electrode layers and the second electrode layers being formed alternately, and
a first side surface electrode and a second side surface electrode respectively connected to the first internal electrode layers and the second internal electrode layers; and
the piezoelectric device element C and the piezoelectric device element D are arranged in parallel to each other on the surface at the trailing edge of the slider, and the magnetic read/write element is arranged so as to link the piezoelectric device element C and the piezoelectric device element D.

6. The magnetic read/write head according to claim 5,
the center of the magnetic read/write element in relation to a direction perpendicular to the displacement axis on the surface at the trailing edge is at the same position as the center of a line connecting the piezoelectric device element C and the center of piezoelectric device element D.

7. The magnetic read/write head according to claim 1, further comprising: wires for communicating, with the magnetic read/write head, a read/write signal to the magnetic read/write element, and a control signal for driving the piezoelectric device, which wires are connected to read/write signal transmission/reception wires provided on the magnetic read/write head via elastic components, respectively.

8. The magnetic read/write head according to claim 1, wherein:
the piezoelectric device is displaced symmetrically with respect to the displacement axis, when a voltage is applied symmetrically with respect to the displacement axis, and is displaced asymmetrically with respect to the displacement axis with respect to the displacement axis, when a voltage is applied asymmetrically with respect to the displacement axis; and
the magnetic read/write element is displaced in a direction perpendicular to the surface at the trailing edge of the slider with the symmetrical displacement of the piezoelectric device, and is rotated about the rotation axis with the asymmetrical displacement of the piezoelectric device.

9. The magnetic read/write head according to claim 8, wherein
the symmetrical displacement is thickening or thinning of the piezoelectric devices by the same amount, on one side and the other side of a plane perpendicular to the surface of the magnetic recording medium and the surface at the trailing edge of the slider, which surface extends through the displacement axis.

10. The magnetic read/write head according to claim 1, wherein
the asymmetrical displacement is thickening the piezoelectric device on one side of a plane perpendicular to the surface of the magnetic recording medium and the surface at the trailing edge of the slider, which surface extends through the displacement axis, and thinning the piezoelectric device on the other side of the plane by the same amount the piezoelectric device on that one side of the plane is thickened.

11. A magnetic read/write apparatus, comprising:
a magnetic read/write head; and
a support arm which supports the magnetic read/write head,
wherein the magnetic read/write head includes
a slider having an ABS facing a magnetic recording medium, a surface perpendicular to an air stream at a leading edge where air flows in a space between the ABS and the magnetic recording medium, and a surface perpendicular to the air stream at a trailing edge where air flows out from the space between the ABS and the magnetic recording medium,
a piezoelectric device arranged on the trailing edge surface of the slider, which is, upon application of voltage, displaced asymmetrically with respect to a displacement axis on the surface at the trailing edge of the slider, the displacement axis being perpendicular to the surface of the magnetic recording medium, and
a magnetic read/write element arranged on the piezoelectric device, which rotates about a rotation axis perpendicular to the surface of the magnetic recording medium with the asymmetrical displacement of the piezoelectric device;
the position of the support arm above the magnetic recording medium is changed by a voice coil motor; and
the magnetic read/write element is moved to a desired data track on the magnetic recording medium by controlling the voice coil motor and the piezoelectric device.
